(19) United States
(12) Patent Application Publication
(10) Pub. No.: US 2020/0269566 A1
(43) Pub. Date: Aug. 27, 2020

(54) INKJET TEXTILE PRINTING DEVICE AND INKJET TEXTILE PRINTING METHOD

(71) Applicant: KYOCERA Document Solutions Inc., Osaka (JP)

(72) Inventor: Jumpei HOBO, Osaka (JP)

(73) Assignee: KYOCERA Document Solutions Inc., Osaka (JP)

(21) Appl. No.: 16/786,584

(22) Filed: Feb. 10, 2020

(30) Foreign Application Priority Data
Feb. 21, 2019 (JP) 2019-028995

(51) Int. Cl. B41J 2/045; B41J 3/407

(52) U.S. Cl. CPC B41J 2/04508; B41J 2/0458; B41J 3/4078

(57) ABSTRACT

An inkjet textile printing device includes: an imaging portion which shoots a textile; a data correction portion which corrects image data for controlling the discharge of an ink based on the shooting data of the textile acquired with the imaging portion so as to acquire correction data; and an inkjet recording portion which directly discharges, based on the correction data, the ink to the textile. The data correction portion corrects, based on the shooting data, the image data to the correction data for discharging, while avoiding a gap between adjacent textile threads in the textile, the ink only on the textile threads.

This application is based upon and claims the benefit of priority from the corresponding Japanese Patent Application No. 2019-028995 filed on Feb. 21, 2019, the entire contents of which are incorporated herein by reference.

### BACKGROUND

The present disclosure relates to an inkjet textile printing device and an inkjet textile printing method which directly discharge an ink to a textile.

Conventionally, a textile printing method is proposed which discharges an ink to a fabric (cloth) with an inkjet method so as to perform printing. The fabric is a textile which is obtained by combining and weaving warp and weft as textile threads, and a gap is present between adjacent textile threads.

In a case where the gaps are present in the fabric as described above, when an ink is directly discharged to the fabric with the inkjet method so as to perform printing, the ink may be passed through the gaps. The ink which is passed through the gaps is not adhered to the fabric so as to be consumed wastefully, and the ink further reaches walls and components within a printer so as to soil the interior of the printer.

Even in a case where a knit is used instead of a fabric, since gaps are present in the knit, when an ink is directly discharged to the knit so as to perform printing, the ink may be passed through the gaps. Consequently, as in the case where the fabric is used, the ink is consumed wastefully and the interior of a printer is soiled. In the following description, the fabric and the knit are also collectively referred to as a “textile”.

A technology is also known in which in order to prevent an ink from being passed through and dropped from gaps in a fabric, paper is adhered to the back surface of the fabric so as to block the gaps in the fabric.

### SUMMARY

An inkjet textile printing device according to one aspect of the present disclosure includes: an imaging portion which shoots a textile; a data correction portion which corrects image data for controlling the discharge of an ink based on the shooting data of the textile acquired with the imaging portion so as to acquire correction data; and an inkjet recording portion which directly discharges, based on the correction data, the ink to the textile. The data correction portion corrects, based on the shooting data, the image data to the correction data for discharging, while avoiding a gap between adjacent textile threads in the textile, the ink only on the textile threads.

An inkjet textile printing method according to another aspect of the present disclosure includes: shooting a textile with an imaging portion; correcting image data for controlling discharge of an ink based on shooting data of the textile acquired with the imaging portion so as to acquire correction data; and directly discharging, based on the correction data, the ink to the textile with an inkjet recording portion. The acquiring of the correction data includes correcting, based on the shooting data, the image data to the correction data for discharging, while avoiding a gap between adjacent textile threads in the textile, the ink only on the textile threads.

Further other objects of the present disclosure and specific advantages obtained by the present disclosure will become more apparent from the description of an embodiment given below.

### BRIEF DESCRIPTION OF THE DRAWINGS

FIG. 1 is an illustrative view showing a schematic configuration of an inkjet textile printing device according to an embodiment of the present disclosure.

FIG. 2 is a block diagram showing a schematic configuration of a main portion of the inkjet textile printing device.

FIG. 3 is a plan view schematically showing the shape of an imaging portion included in the inkjet textile printing device.

FIG. 4 is a plan view schematically showing a state of textile threads in a textile.

FIG. 5 is an enlarged plan view of a P portion in FIG. 4.

FIG. 6 is an illustrative view showing examples of shooting data, image data and correction data.

FIG. 7 is an illustrative view schematically showing a state where a letter is printed on the textile by the discharge of inks based on the correction data.

FIG. 8 is a plan view showing another configuration of the imaging portion.

FIG. 9 is a plan view showing another configuration of an inkjet recording portion included in the inkjet textile printing device.

FIG. 10 is a plan view showing yet another configuration of the inkjet recording portion.

FIG. 11 is a plan view showing still another configuration of the inkjet recording portion.

### DETAILED DESCRIPTION

In a technology in which in order to prevent an ink from being passed through and dropped from gaps in a fabric, paper is adhered to the back surface of the fabric so as to block the gaps in the fabric, it is inconvenient that before the discharge of the ink, special pretreatment for adhering the paper to the back surface of the fabric is needed.

In the present disclosure, an inkjet textile printing device is provided which can reduce, without performing the special pretreatment for blocking the gaps in the textile before the discharge of the ink, the passage of the ink through the gaps in the textile, and in which thus it is possible to reduce an increase in the consumed amount of wasted ink caused by the passage of the ink through the gaps and to reduce the contamination of the interior of the device.

[Schematic Configuration of Inkjet Textile Printing Device]

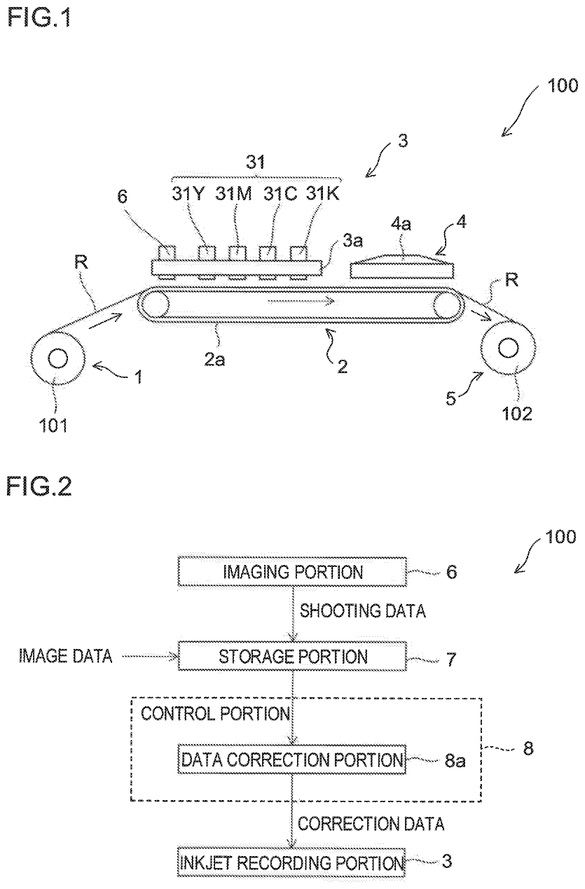

An embodiment of the present disclosure will be described below with reference to drawings. FIG. 1 is an illustrative view showing a schematic configuration of an inkjet textile printing device 100 according to the embodiment of the present disclosure. FIG. 2 is a block diagram showing a schematic configuration of a main portion of the inkjet textile printing device 100. The inkjet textile printing device 100 is a so-called direct inkjet textile printer which directly discharges inks toward a textile R serving as a recording medium so as to perform textile printing. The inkjet textile printing device 100 includes a feed-out portion 1, a transport portion 2, an inkjet recording portion 3, a dry portion 4, a collection portion 5, an imaging portion 6, a storage portion 7 and a control portion 8. Here, as the textile R, a fabric is assumed.

The feed-out portion 1 uses a motor (unillustrated) to rotate a roll medium 101 in which the textile R is wound in the shape of a roll, and thereby feeds out the textile R from the roll medium 101.

The transport portion 2 attaches the textile R fed out from the feed-out portion 1 to a transport belt 2a so as to transport the textile R (belt transport method). The transport portion 2 may apply tension to the textile R with the roll so as to transport the textile R. Although the transport portion 2 is provided opposite both the inkjet recording portion 3 and the dry portion 4, the transport portion 2 may be divided into part which is opposite the inkjet recording portion 3 and part which is opposite the dry portion 4.

The inkjet recording portion 3 directly discharges inks to the textile R which is transported with the transport portion 2, and thereby records an image on the textile R. The inkjet recording portion 3 includes inkjet head 31 which is held in a head housing 3a. The inkjet head 31 includes inkjet heads 31Y, 31M, 31C and 31K. The inkjet heads 31Y, 31M, 31C an 31K discharge the inks of individual colors of yellow (Y), magenta (M), cyan (C) and black (K) toward the textile R. The inkjet heads 31Y to 31K are held in the head housing 3a so as to form a predetermined distance (for example, 3 mm) with respect to the transport surface of the transport portion 2 arranged opposite the inkjet recording portion 3. The inkjet heads 31Y to 31K are line heads which are extended over the entire textile R in a width direction perpendicular to a transport direction thereof, and are located from an upstream side toward a downstream side in the transport direction of the textile R in this order.

Although in the present embodiment, the inkjet head 31 includes the four inkjet heads 31Y to 31K corresponding to the four colors, for example, the inkjet head 31 may be formed with only the inkjet head 31K corresponding to black (K). In other words, the inkjet head 31 is preferably formed so as to include inkjet heads which correspond in number to at least one color.

The inkjet recording portion 3 directly discharges, based on a control signal (correction data which will be described later) from the control portion 8, the inks from the discharge nozzles (unillustrated) of the inkjet heads 31Y to 31K toward the textile R. In this way, a color image in which the inks of the four colors of yellow, magenta, cyan and black are superimposed is formed on the textile R.

The inkjet head 31 may be either of a piezo type and a thermal type. The inks used may be any one of a reactive dye, an acid dye, a disperse dye and a pigment.

The dry portion 4 includes a fan 4a which is arranged opposite the transport surface of the transport portion 2. The dry portion 4 blows an air flow from the fan 4a toward the textile R transported with the transport belt 2a of the transport portion 2, and thus the inks on the textile R are dried. The drying of the inks with the dry portion 4 is preferably performed as necessary (for example, according to the inks used).

The collection portion 5 winds and collects, in the shape of a roll, the textile R to which the inks are discharged with the inkjet recording portion 3 and in which the inks are dried with the dry portion 4, and thereby obtains a roll-shaped recorded medium 102.

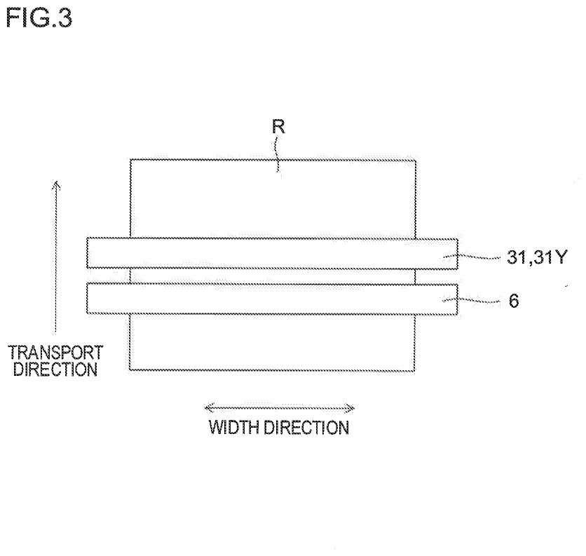

The Imaging portion 6 is formed with a camera which shoots the textile R. FIG. 3 is a plan view schematically showing the shape of the imaging portion 6. The imaging portion 6 is extended in the shape of a line over the entire textile R in the width direction. The imaging portion 6 is located on the upstream side in the transport direction of the textile R with respect to the inkjet head 31 (for example, the inkjet head 31Y) in the inkjet recording portion 3. Although in the present embodiment, the imaging portion 6 is held in the same head housing 3a as that of the inkjet head 31 (see FIG. 1), the imaging portion 6 may be held in a housing different from the head housing 3a.

The storage portion 7 is a memory which stores various types of data and an operation program for the control portion 8, and is selected, as necessary, from a ROM, a RAM, a hard disk, a portable recording medium and the like. Examples of the data stored in the storage portion 7 include shooting data acquired by shooting the textile R with the imaging portion 6, image data for controlling the discharge of the inks and the like. The image data is supplied from, for example, an external PC. The shooting data and the image data are temporarily stored in the storage portion 7 and are thereafter fed to the control portion 8. The image data is, for example, data which is obtained by converting, with the external PC, an image to be printed. For example, the discharge of the inks based on the image data is performed on a substantially uniform recording medium such as paper, and thus it is possible to print the image.

The control portion 8 is formed with, for example, a CPU, and controls the operations of the individual portions of the inkjet textile printing device 100 according to the operation program stored in the storage portion 7. In particular, the control portion 8 includes a data correction portion 8a. The data correction portion 8a corrects the image data based on the shooting data of the textile R acquired with the imaging portion 6 so as to acquire the correction data. More specifically, based on the shooting data acquired with the imaging portion 6, the data correction portion 8a corrects the image data to the correction data for discharging, while avoiding a gap between adjacent textile threads in the textile R, the inks only on the textile threads.

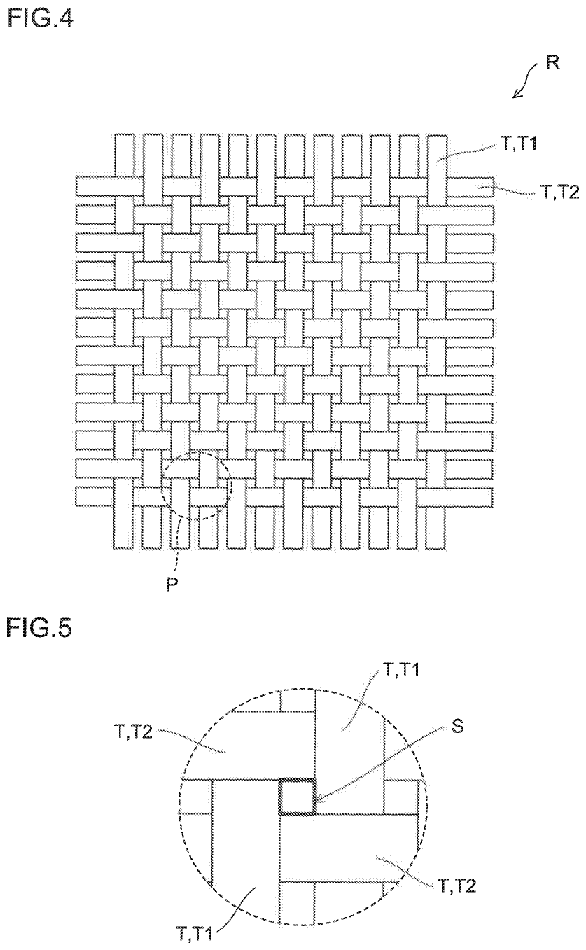

Here, FIG. 4 is a plan view schematically showing a state of the textile threads T in the textile R, and FIG. 5 is an enlarged plan view of a P portion in FIG. 4. The textile R serving as a fabric is obtained by weaving the textile threads T. The textile threads T are formed with warp T1 and weft T2. In the textile R obtained by weaving the warp T1 and the weft T2 as described above, as shown in FIG. 5, between adjacent pieces of the warp T1 or between adjacent pieces of the weft T2, a gap S (which is indicated by thick lines in FIG. 5 for convenience) is present. The size of the gap S differs depending on the type (thickness or material) of textile threads T and how to weave the textile threads.

The adjacent pieces of the warp T1 between which the gap S is sandwiched may be obtained by folding the same textile thread or may be textile threads of different types (for example, colors, thicknesses or materials). Likewise, the adjacent pieces of the weft T2 between which the gap S is sandwiched may be obtained by folding the same textile thread or may be textile threads of different types.

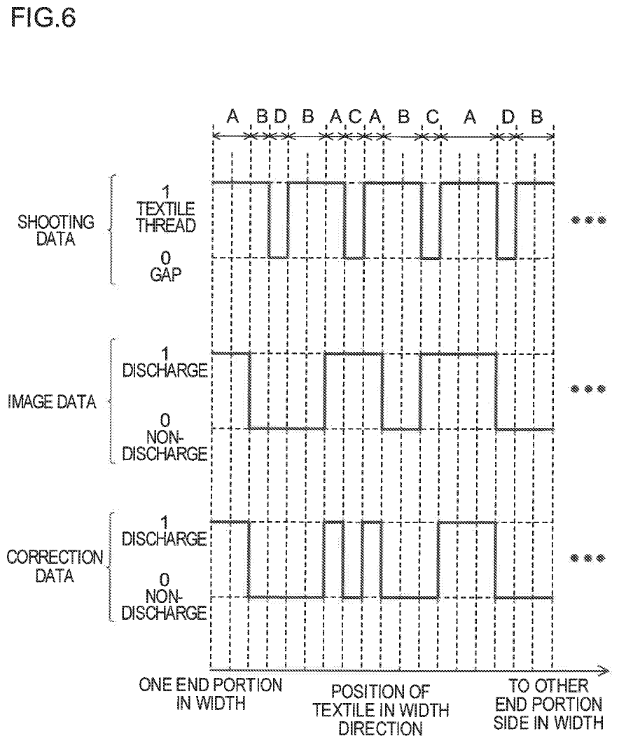

The data correction portion 8a described above can obtain the correction data as follows based on the shooting data acquired with the imaging portion 6. FIG. 6 is an illustrative view showing examples of the shooting data, the image data and the correction data. The horizontal axis of FIG. 6 corresponds to the position of the textile R in the width direction. Here, for ease of understanding of the description, the shooting data is indicated by binary data of a high level (level 1) indicating a position in which the textile thread T is present in the textile R and a low level (level 0) indicating the position of the gap S in the textile R. The data correction portion 8a recognizes the color of the textile thread T and a color (for example, black indicating the gap S) other than the color of the textile thread T based on, for example, the shooting data of red (R), green (G) and blue (B) acquired with the imaging portion 6, and thereby can make a determination by distinguishing between the position of the textile thread T and the position of the gap S in the textile R. Here, as the image data, binary data is considered which includes a discharge level (level 1) at which the inks are discharged from the inkjet recording portion 3 and a non-discharge level (level 0) at which the discharge of the inks is stopped.

The data correction portion 8a simply multiplies together the level (1 or 0) of the shooting data and the level (1 or 0) of the image data in the same position of the textile R so as to be able to obtain the correction data. For example, in the textile R, in a section A in which the level of the shooting data is 1 and the level of the image data is 1, these levels are multiplied together, and thus the level of the correction data is 1. In other words, when a position is located in the textile thread T of the textile R and the image data of the position is the discharge level, the correction data of the position is the discharge level.

In the textile R, in a section B in which the level of the shooting data is 1 and the level of the image data is 0, these levels are multiplied together, and thus the level of the correction data is 0. In other words, when a position is located in the textile thread T of the textile R and the image data of the position is the non-discharge level, the correction data of the position is the non-discharge level.

In the textile R, in a section C in which the level of the shooting data is 0 and the level of the image data is 1, these levels are multiplied together, and thus the level of the correction data is 0. In other words, when a position is located in the gap S of the textile R and the image data of the position is the discharge level, the correction data of the position is the non-discharge level.

In the textile R, in a section D in which the level of the shooting data is 0 and the level of the image data is 0, these levels are multiplied together, and thus the level of the correction data is 0. In other words, when a position is located in the gap S of the textile R and the image data of the position is the non-discharge level, the correction data of the position is the non-discharge level.

Specifically, the level of the shooting data and the level of the image data are multiplied together as described above, and thus the correction data is obtained, with the result that, with respect to the image data corresponding to the position (section A or B) of the textile thread T in the textile R, the discharge level (level 1) or the non-discharge level (level 0) included in the image data is maintained in the correction data without being changed. More specifically, in the section A, the discharge level included in the image data is maintained as the discharge level in the correction data without being changed, and in the section B, the non-discharge level included in the image data is maintained as the non-discharge level in the correction data without being changed. On the other hand, with respect to the image data corresponding to the position (section C or D) of the gap S in the textile R, the discharge level or the non-discharge level included in the image data is uniformly the non-discharge level in the correction data. More specifically, in the section C, the discharge level included in the image data is changed to the non-discharge level in the correction data. In the section D, the non-discharge level included in the image data is maintained as the non-discharge level in the correction data without being changed.

In this way, the data correction portion 8a corrects the image data based on the shooting data so as to be able to acquire the correction data for discharging, while avoiding the gap S in the textile R, the inks only on the textile threads T. Hence, the inkjet recording portion 3 discharges the inks on the textile R based on the correction data described above so as to be able to discharge the inks only on the textile threads T in the textile R, and thus it is possible to avoid the discharge of the inks to the gaps S in the textile R.

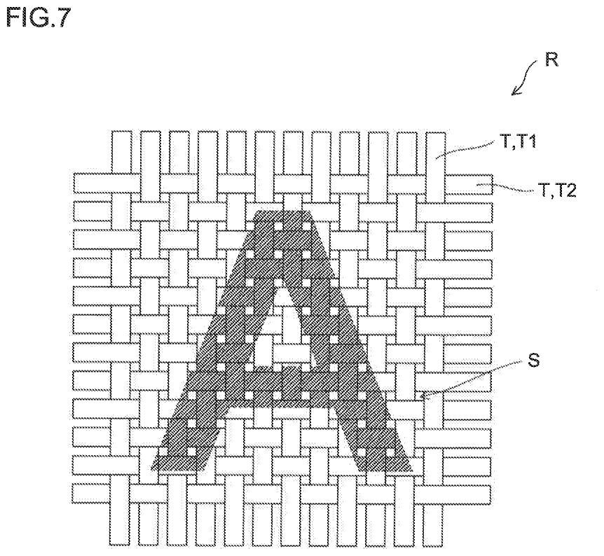

FIG. 7 schematically shows a state where, for example, the letter “A” of the alphabet is printed on the textile R by the discharge of the inks based on the correction data described above. In FIG. 7, for convenience, parts to which the inks are discharged are hatched. As in the figure, since the inks are not discharged to the gaps S in the textile R, it is possible to reduce an increase in the consumed amount of wasted inks caused by the passage of the inks through the gaps and to reduce the contamination of the interior of the device. Moreover, the inks are prevented from being passed through the gaps S, and thus it is not necessary to perform, before the discharge of the inks, the special pretreatment for blocking the gaps in the textile such as the adhering of paper to the back surface of the textile. Hence, by a simple method of correcting the image data without performing the burdensome pretreatment before the discharge of the inks, it is possible to reduce an increase in the consumed amount of wasted inks passed through the gaps and to reduce the contamination of the interior of the device caused by the inks described above.

The data correction portion 8a recognizes, based on the shooting data acquired with the imaging portion 6, the positions of the textile threads T and the positions of the gaps S in the textile R. Then, the data correction portion 8a maintains, on the image data corresponding to the position of the textile thread T, the discharge level or the non-discharge level included in the image data without being changed whereas on the image data corresponding to the position of the gap S, the data correction portion 8a converts the discharge level included in the image data to the non-discharge level or maintains the non-discharge level included therein so as to acquire the correction data described above. In this way, in the inkjet recording portion 3, on the textile threads T in the textile R, based on the correction data (in which the image data before being corrected is maintained without being changed), the discharge/non-discharge of the inks is performed. On the other hand, on the gaps S in the textile R, based on the correction data (the non-discharge level), the discharge of the inks from the inkjet recording portion 3 is stopped. Hence, it is possible to reliably drive the inkjet recording portion 3 such that the inks are discharged only on the textile threads T and are not discharged to the gaps S.

In the present embodiment, the imaging portion 6 and the inkjet head 31 of the inkjet recording portion 3 are extended in the shape of a line over the entire textile R in the width direction, and the imaging portion 6 is located on the upstream side in the transport direction of the textile R with respect to the inkjet head 31. In such a positional relationship, the textile R which is shot with the imaging portion 6 is thereafter transported to a position in which the ink is discharged with the inkjet head 31 on the downstream side in the transport direction. Hence, the ink can be discharged with the inkjet head 31 to the position previously shot with the imaging portion 6, and it is possible to reliably drive the inkjet recording portion 3 such that the image data is corrected based on the shooting data as described above and that the ink is discharged based on the correction data. Since the imaging portion 6 is extended in the shape of a line over the entire textile R in the width direction, it is possible to acquire, while transporting the textile R with the transport portion 2 without stopping the textile R, the shooting data by shooting the textile R continuously.

Incidentally, the textile R is elasticized. For example, when tension in the transport direction is applied to the textile R, the textile R is expanded in the transport direction but is contracted in the width direction perpendicular to the transport direction. The textile R is also contracted by absorbing water contained in the discharged inks. Hence, when a time interval between a timing at which the textile R is shot with the imaging portion 6 and a timing at which the inks are discharged with the inkjet recording portion 3 is prolonged, the following problem may occur. Specifically, when the textile R is expanded and contracted between the shooting timing and the discharge timing, the position in which the inks are actually discharged with the inkjet recording portion 3 may be displaced from the position of the textile thread T such that the inks are discharged to the gap S in the textile R.

Hence, the imaging portion 6 preferably shoots, immediately before the discharge of the inks with the inkjet recording portion 3, the textile R so as to acquire the shooting data. Preferably, for example, in a configuration in which the inkjet head 31 of the inkjet recording portion 3 discharges the ink with a resolution of 600 dpi, a position one inch or less apart from the position in which the ink is discharged to the upstream side in the transport direction of the textile R and more preferably a position one to several tens of dots apart from the position in which the ink is discharged to the upstream side is shot with the imaging portion 6, and thus the shooting data is acquired. In this case, the time interval between the timing at which the textile R is shot with the imaging portion 6 and the timing at which the ink is discharged with the inkjet recording portion 3 is shortened, and thus it is possible to minimize the influence of the expansion and contraction of the textile R between the shooting timing and the discharge timing. In this way, it is possible to reliably reduce the problem where the position in which the ink is actually discharged with the inkjet recording portion 3 is displaced from the position of the textile thread T and where thus the ink is discharged to the gap S in the textile R.

[Variations of Inkjet Textile Printing Device]

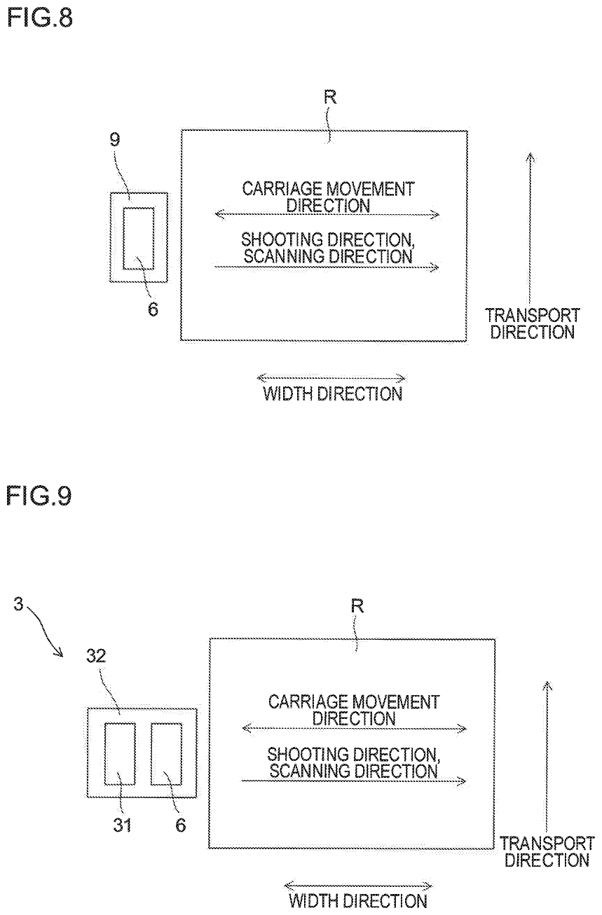

The imaging portion 6 of the inkjet textile printing device 100 is not limited to the imaging portion 6 in the shape of a line described above. FIG. 8 is a plan view showing another configuration of the imaging portion 6. The imaging portion 6 may be shorter in length than the textile R in the width direction. Preferably, in this case, the imaging portion 6 is mounted on a carriage 9 which reciprocates in the width direction of the textile R, in a state where the textile R is stopped, while the carriage 9 is being moved in the width direction of the textile R, the textile R is scanned in one direction (for example, in FIG. 8, a direction extending from left to right) so as to be shot, the textile R is thereafter transported, the carriage 9 is moved again so as to scan and shoot the subsequent line in the one direction and such a step is thereafter repeated. In this way, it is possible to shoot the entire textile R with the imaging portion 6.

FIG. 9 is a plan view showing another configuration of the inkjet recording portion 3 of the inkjet textile printing device 100. The inkjet recording portion 3 may include a carriage 32 which mounts the inkjet head 31 and which is moved in the width direction perpendicular to the transport direction of the textile R. Here, the inkjet head 31 is a serial head which discharges the ink while being moved in the width direction with respect to the textile R by the movement of the carriage 32. In the configuration of the inkjet recording portion 3 as described above, the carriage 32 may further mount the imaging portion 6 described above in addition to the inkjet head 31. The moving speed of the carriage 32 is, for example, about 1 m/sec.

Since the imaging portion 6 is mounted on the same carriage as the carriage 32 which mounts the inkjet head 31 (serial head), the shooting of the textile R with the imaging portion 6 and the discharge of the ink with the inkjet head 31 can be performed by the movement of the single carriage 32. A dedicated movement mechanism (carriage 9) for independently moving the imaging portion 6 as shown in FIG. 8 does not need to be provided separately from the carriage 32 which moves the inkjet head 31. Hence, the movement mechanism described above does not need to be provided, and the configuration of the device can be simplified accordingly.

In the configuration in which the carriage 32 described above is reciprocated in the width direction of the textile R, the imaging portion 6 may scan and shoot, by the movement of the carriage 32 in one direction (for example, in FIG. 9, a direction extending from left to right), the textile R in the one direction. Preferably, in this case, as shown in FIG. 9, the carriage 32 mounts the imaging portion 6 on the downstream side in the scanning direction of the one direction with respect to the inkjet head 31.

In the configuration as described above, in the scanning direction of the one direction, the textile R is first shot with the imaging portion 6 on the downstream side such that the shooting data is acquired, and thereafter the data correction portion 8a acquires the correction data based on the acquired shooting data, with the result that based on the acquired correction data, the inkjet head 31 on the upstream side can discharge the ink. In other words, the shooting (acquisition of the shooting data) of the textile R with the imaging portion 6 and the discharge of the ink with the inkjet head 31 can be performed continuously.

The continuous performance of the shooting and the discharge of the inks also results in the acquisition of the shooting data by shooting the textile R with the imaging portion 6 immediately before the discharge of the ink with the inkjet head 31. In this case, as described previously, it is possible to minimize the influence of the expansion and contraction of the textile R between the shooting timing and the discharge timing. Hence, it is possible to reduce the problem where the position in which the ink is actually discharged is affected by the expansion and contraction of the textile R so as to be displaced from the position of the textile thread T and where thus the ink is discharged to the gap S in the textile R.

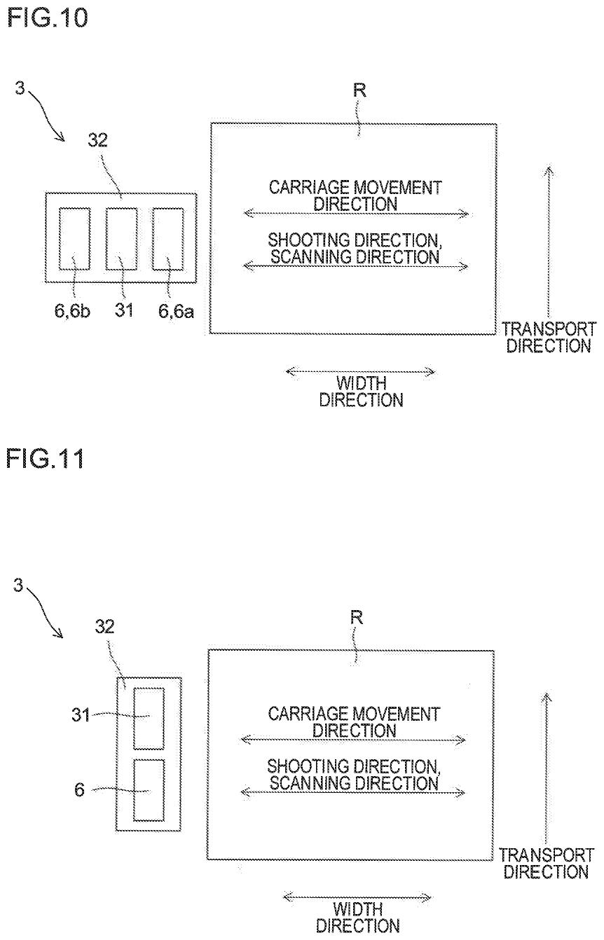

FIG. 10 is a plan view showing yet another configuration of the inkjet recording portion 3. In the configuration in which the carriage 32 of the inkjet recording portion 3 mounts both the inkjet head 31 and the imaging portion 6, the imaging portion 6 may include two imaging portions, that is, a first imaging portion 6a and a second imaging portion 6b. Here, the first imaging portion 6a scans and shoots, by the movement of the carriage 32 reciprocating in the width direction in one direction (for example, in FIG. 10, a direction extending from left to right), the textile R in the one direction. The second imaging portion 6b scans and shoots, by the movement of the carriage 32 in a direction opposite to the one direction (for example, in FIG. 10, a direction extending from right to left), the textile R in the opposite direction.

Preferably, in this case, the carriage 32 mounts the first imaging portion 6a on the downstream side in the scanning direction of the one direction with respect to the inkjet head 31, and mounts the second imaging portion 6b on the downstream side in the scanning direction of the opposite direction with respect to the inkjet head 31. In other words, in the carriage 32, the second imaging portion 6b, the inkjet head 31 and the first imaging portion 6a are preferably located from the upstream side in the one direction in this order. In this configuration, the shooting data is acquired by the bidirectional scanning of the textile R (while the scanning direction is alternately reversed), and thus it is possible to discharge the ink with the inkjet head 31.

More specifically, in the scanning direction of the one direction, the textile R is first shot with the first imaging portion 6a on the downstream side such that the shooting data is acquired, and thereafter the data correction portion 8a acquires the correction data based on the acquired shooting data, with the result that based on the acquired correction data, the inkjet head 31 on the upstream side can discharge the ink. In the scanning direction of the opposite direction, the textile R is first shot with the second imaging portion 6b on the downstream side such that the shooting data is acquired, and thereafter the data correction portion 8a acquires the correction data based on the acquired shooting data, with the result that based on the acquired correction data, the inkjet head 31 on the upstream side can discharge the ink.

FIG. 11 is a plan view showing still another configuration of the inkjet recording portion 3. In the configuration in which the imaging portion 6 scans and shoots, by the movement of the carriage 32 in the width direction, the textile R in the width direction (the one direction and the direction opposite thereto), the carriage 32 may mount the imaging portion 6 on the upstream side in the transport direction of the textile R with respect to the inkjet head 31. Even in this configuration in which only one imaging portion 6 is used, while the shooting data is being acquired by the bidirectional scanning of the textile R (by alternately reversing the scanning direction), it is possible to discharge the ink with the inkjet head 31.

Specifically, the textile R is first shot with the imaging portion 6 located on the upstream side in the transport direction such that the shooting data is acquired, and thereafter the data correction portion 8a acquires the correction data based on the acquired shooting data, with the result that based on the acquired correction data, the inkjet head 31 on the downstream side in the transport direction can discharge the ink.

Although in the present embodiment, the example where the fabric is used as the textile R is described, the configuration of the present embodiment and the control of the discharge of the inks can also be applied to a case where a knit is used, and thus it is possible to obtain the same effects as in the present embodiment. Specifically, the knit is a textile which is made by weaving textile threads, and thus as in a cloth, a gap is present between adjacent textile threads. Hence, the control of the discharge of the inks based on the correction data described in the present embodiment is performed, and thus the inks are prevented from being discharged to the gaps in the knit, with the result that it is possible to reduce an increase in the consumed amount of wasted inks passed through the gaps and to reduce the contamination of the interior of the device caused by the inks described above.

As described above, in the present embodiment, based on the correction data acquired with the data correction portion, the inkjet recording portion directly discharges the inks to the textile, and thus the inks are discharged only on the textile threads while avoiding the gaps in the textile. In this way, it is possible to reduce the passage of the inks through the gaps in the textile without performing the special pretreatment for blocking the gaps in the textile before the discharge of the inks. Hence, it is possible to reduce an increase in the consumed amount of wasted inks caused by the passage of the inks through the gaps without performing the special pretreatment and to reduce the contamination of the interior of the device.

Although in the present embodiment, the color inkjet textile printing device 100 which includes the inkjet head 31 corresponding to the four colors is described, the configuration and the control of the present embodiment can also be applied to a monochrome inkjet textile printing device.

The present disclosure can be utilized for an inkjet textile printing device which directly discharges inks to a textile.

Although the embodiment of the present disclosure has been described above, the scope of the present disclosure is not limited to this embodiment, and it is possible to add and practice various modifications without departing from the spirit of the disclosure.

What is claimed is:

1. An inkjet textile printing device comprising:
an imaging portion which shoots a textile;
a data correction portion which corrects image data for controlling discharge of an ink based on shooting data of the textile acquired with the imaging portion so as to acquire correction data; and
an inkjet recording portion which directly discharges, based on the correction data, the ink to the textile,
wherein the data correction portion corrects, based on the shooting data, the image data to the correction data for discharging, while avoiding a gap between adjacent textile threads in the textile, the ink only on the textile threads.

2. The inkjet textile printing device according to claim 1,
wherein the image data includes a discharge level at which the ink is discharged from the inkjet recording portion and a non-discharge level at which the discharge of the ink is stopped,
based on the shooting data, the data correction portion maintains, with respect to the image data corresponding to a position of the textile thread, the discharge level or the non-discharge level included in the image data without being changed whereas with respect to the image data corresponding to a position of the gap, the data correction portion converts the discharge level included in the image data to the non-discharge level or maintains the non-discharge level included therein so as to acquire the correction data.

3. The inkjet textile printing device according to claim 1,
wherein the imaging portion shoots the textile immediately before the discharge of the ink with the inkjet recording portion so as to acquire the shooting data.

4. The inkjet textile printing device according to claim 1, further comprising:
a transport portion which transports the textile,
wherein the inkjet recording portion includes an inkjet head which discharges the ink,
the imaging portion and the inkjet head are extended over the entire textile in a width direction perpendicular to a transport direction thereof and
the imaging portion is located on an upstream side in the transport direction of the textile with respect to the inkjet head.

5. The inkjet textile printing device according to claim 1, further comprising:
a transport portion which transports the textile,
wherein the inkjet recording portion includes:
an inkjet head which discharges the ink; and
a carriage which mounts the inkjet head and which is moved in a width direction perpendicular to a transport direction of the textile,
the inkjet head is a serial head which discharges the ink while being moved in the width direction with respect to the textile by the movement of the carriage and
the carriage further mounts the imaging portion in addition to the inkjet head.

6. The inkjet textile printing device according to claim 5,
wherein the imaging portion scans and shoots, by the movement of the carriage reciprocating in the width direction in one direction, the textile in the one direction, and
the carriage mounts the imaging portion on a downstream side in a scanning direction of the one direction with respect to the inkjet head.

7. The inkjet textile printing device according to claim 5,
wherein the imaging portion includes:
a first imaging portion which scans and shoots, by the movement of the carriage reciprocating in the width direction in one direction, the textile in the one direction; and
a second imaging portion which scans and shoots, by the movement of the carriage in a direction opposite to the one direction, the textile in the opposite direction, and
the carriage mounts the first imaging portion on a downstream side in a scanning direction of the one direction with respect to the inkjet head, and mounts the second imaging portion on the downstream side in the scanning direction of the opposite direction with respect to the inkjet head.

8. The inkjet textile printing device according to claim 5,
wherein the imaging portion scans and shoots, by the movement of the carriage in the width direction, the textile in the width direction, and
the carriage mounts the imaging portion on an upstream side in the transport direction of the textile with respect to the inkjet head.

9. An inkjet textile printing method comprising:
shooting a textile with an imaging portion;
correcting image data for controlling discharge of an ink based on shooting data of the textile acquired with the imaging portion so as to acquire correction data; and
directly discharging, based on the correction data, the ink to the textile with an inkjet recording portion,
wherein the acquiring of the correction data includes correcting, based on the shooting data, the image data to the correction data for discharging, while avoiding a gap between adjacent textile threads in the textile, the ink only on the textile threads.
